(19) United States
(12) Patent Application Publication
(10) Pub. No.: US 2025/0012021 A1
(43) Pub. Date: Jan. 9, 2025

(54) Self-propelled earth working machine comprising at least one variably positionable operating module

(71) Applicant: Wirtgen GmbH, Windhagen (DE)

(72) Inventor: Michael Schwarz, Bad Honnef (DE)

(21) Appl. No.: 18/752,193

(22) Filed: Jun. 24, 2024

(30) Foreign Application Priority Data
Jul. 3, 2023 (DE) 10 2023 117 547.5

(51) Int. Cl. E01C 19/48

(52) U.S. Cl. CPC E01C 19/4893

(57) ABSTRACT

A self-propelled earth working machine includes a control apparatus including an operating module including a plurality of selectively actuatable operating elements. An at least two-part housing is configured to receive the operating module, the housing including a lower shell and an upper shell movable relative to each other between a closed position and an open position. The operating elements of the operating module when the operating module is received in the housing are accessible in the open position of the housing. The operating module is separable from the housing and the operating module can be positioned on either of the upper shell and the lower shell in a functionally ready mode.

### RELATED APPLICATION

The present application claims priority to German Patent Application Ser. No. 10 2023 117 547.5 filed Jul. 3, 2023, which is incorporated herein by reference.

### BACKGROUND OF THE DISCLOSURE

### Field of the Disclosure

The present disclosure relates to a self-propelled earth working machine, comprising a machine frame, a traveling gear supporting the machine frame, a travel drive and an earth working apparatus designed for earth working, wherein the earth working machine comprises a control apparatus for controlling an operation of the earth working machine, wherein the control apparatus comprises an operating module having a plurality of selectively actuatable operating elements, the actuation of which is suitable for changing an operating state of the earth working machine, wherein the control apparatus comprises an at least two-part housing, in which the operating module is accommodated, wherein the housing comprises a lower shell and an upper shell, which are movable relative to each other between a closed position and an open position, wherein the operating elements of the operating module accommodated in the housing are accessible in the open position of the housing. The housing and the at least one operating module together form an operating apparatus.

In the open position of the housing, the operating elements are accessible to a greater extent than in its closed position. This may be realized in that in the open position of the housing, more operating elements are accessible than in its closed position and/or in that in the open position of the housing, operating elements are accessible with less effort than in its closed position. Preferably, a large portion of the operating elements, particularly preferably all operating elements, are not accessible in the closed position of the housing.

### Description of the Prior Art

Such an earth working machine is known, for example, from EP 3 524 461 A1 (U.S. Pat. No. 10,735,042). There, a road milling machine, a recycler and a surface miner are mentioned, by way of example, as possible earth working machines. In the closed position, the upper shell and the lower shell hide the operating module completely in order to protect it against attacks of vandalism. Such attacks of vandalism occasionally occur when the earth working machine is parked over night on a construction site and persons with a destructive intent gain access to the construction site.

In the known operating apparatus composed of the housing and the operating module, the operating module is firmly anchored in the lower shell and, in the closed position, may be covered entirely by the upper shell. In the open position, the upper shell is completely detached from the lower shell in the known operating apparatus and may be stowed far away from the lower shell for the duration of the operation of the earth working machine. The known upper shell has an essentially planar panel shape with a few stiffening corrugations.

Proceeding from this related art, an objective of the present disclosure is to provide an operating apparatus composed of a housing and an operating module, which, while continuing to provide protection against vandalism at times when the earth working machine is not in use, also has an improved adaptability to different operating situations during the operation of the earth working machine in order to support the machine operator working on the earth working machine even better in his activity.

US 2015/0321597 A1 discloses a wireless operating apparatus for components of a vehicle, the portable housing of which comprises a lower shell and an upper shell and an operating module situated therein in removable fashion if desired. The operating module is connectible only to the lower shell. The upper shell is connected in pivoting fashion to the lower shell. By way of a separate holding device, the known operating apparatus may be situated on the belt of the machine operator or in the operator cab of the vehicle.

U.S. Pat. No. 7,953,517 B1 and U.S. Pat. No. 10,069,284 B1 respectively disclose an operating device for controlling irrigation systems. Each operating device is accommodated in a plastic housing comprising a lower shell and an upper shell anchored to it in pivoting fashion. The operating device itself is connected to the housing in pivoting fashion relative to the housing. The pivot axes of the housing shells on the one hand and of the operating device on the other hand are parallel or collinear with respect to each other.

### SUMMARY OF THE DISCLOSURE

According to the present disclosure, the aforementioned objective is achieved by a self-propelled earth working machine mentioned at the outset, in which the operating module is detachable from the housing and positionable on the housing, it being possible to position the operating module functionally ready on any shell of upper shell and lower shell.

“Functionally ready” in this context means that in the operationally ready state of the earth working machine with the operating module switched on, the operating elements are accessible as intended for a machine operator controlling the earth working machine. At least a portion of the operating elements, preferably all operating elements of the operating module, are connected in signal-transmitting fashion to a data processing system of the control apparatus in such a way that their actuation results in a predictable manner in state changes of functional apparatuses of the earth working machine. Thus, actuations of operating elements of the operating module are able to control various actuators of the earth working machine in order, for example, to move the earth working machine by way of the travel drive and/or to change the direction of travel of the earth working machine while it is moving by steering the traveling gear and/or to control an operation of the earth working apparatus, to mention only a few examples.

Although the operating module may also be accommodated and normally will be accommodated in one of the two shells when switched off, the housing does not only serve to transport the operating module between a stowage location and a location of use. Rather, the housing serves to anchor the operating module securely in a working area of a machine operator of the earth working machine in the functionally ready state and preferably also in an idle state, in which the earth working machine is switched off at a standstill.

Depending on the type and extent of the earth working operation, which the earth working machine is able to perform on account of the earth working apparatus attached to it, the operating apparatus composed of housing and operating module may be situated at different locations of the earth working machine. The earth working machine preferably comprises an operator platform, on which the machine operator is located at least during the operation of the earth working machine in order to control it. The operating apparatus is therefore preferably situated on an operator platform, particularly preferably within reach of an adult around a possibly provided operator seat and/or within reach of an adult standing on an operator platform floor.

The operating module is preferably situated in a shell of upper shell and lower shell in such a way that the operating module is physically connected to the shell and is held on the shell.

The housing preferably has a housing volume, in which the operating module is accommodated when positioned as intended in a shell, the housing volume being enclosed by the housing in the closed position. In the closed position, the housing is thus able to protect the operating module against access from outside. Feed-through openings may form an exception to the enclosed envelopment of the housing volume by the housing, which feed-through openings may be provided on the housing in order to allow for connecting lines for transmitting signals and/or energy between a component of the earth working machine and the operating module.

Because the operating module may in principle be situated in any shell of upper shell and lower shell, there are fundamentally two different locations available for positioning the operating module. Depending on where the machine operator is located during the earth working operation or even during a mere travel operation of the earth working machine, the machine operator can position the operating module in a functionally ready state in the shell of upper shell and lower shell that is respectively closer to his location and is thus able to remain at his location for controlling the operation of the earth working machine or has to leave this location only slightly and/or briefly.

In order to protect the operating module without having to relocate it after the end of a work shift and after switching off the earth working machine, it is preferably provided that the operating module can be positioned on a respective inner side of the upper shell or of the lower shell or is so positioned at least during an operation of the earth working machine. Regardless of whether the operating module is currently situated in the upper shell or in the lower shell, the operating module can then remain in the housing and be protected against unwelcome access from outside by bringing the housing into its closed position.

Preferably, the operating module can be positioned respectively only on the inner side of the upper shell and on the inner side of the lower shell or is positioned on the inner side of the shell of upper shell and lower shell respectively selected for positioning the operating module.

To remove doubts, it shall be clarified that the inner sides of the upper shell and the lower shell are those sides of the mentioned shells that lie opposite each other and/or face each other in the closed position of the housing.

To make it possible that each of the shells of upper shell and lower shell designed to accommodate the operating module is able not only to hold the operating module as such, but also able to surround and shield it on those sides on which the machine operator does not require operating access, a preferred development of the present disclosure provides for each shell of upper shell and lower shell to comprise in each case a concave inner side formed for accommodating the operating module. The inner sides of the upper shell and the lower shell are each configured to accommodate the operating module.

In order to facilitate positioning the operating module in one of the shells of upper shell and lower shell, while minimizing error, inner sides of the upper shell and the lower shell on the one hand and the outer side of the operating module lying opposite the respective inner side of the shell in the operationally ready state are preferably designed to be complementary. An advantageously short set-up time of the operating apparatus may be achieved when using a self-centering effect of the operating module in the shell selected for positioning it in that the inner side of the shell is tapered from an edge of the shell to a bottom of the shell, i.e., in that a clear area surrounded by the respective inner side of the shell becomes smaller when approaching the bottom of the shell starting from the edge of the shell.

The edge of the shell is in this case the edge of the upper shell and of the lower shell that bounds the opening area of the respective shell radially outwardly, through which opening area the operating module is inserted into the respective shell. In the closed position of the housing, the edges of the upper shell and of the lower shell are drawn near each other. They preferably overlap each other in their direction of approach in order to make it difficult to pry the housing open from the closed position by inserting a tool into a gap formed between upper shell and lower shell.

Preferably, the section of the outer side of the operating module, which is surrounded by the upper shell or the lower shell in the functionally ready state of the operating module, is tapered in complementary fashion starting from a control panel supporting the operating elements to a bottom of the operating module opposite the control panel. Preferably, at least sections of the outer side of the operating module and of the inner side of the shell accommodating the operator module abut against each other in the functionally ready state of the operating module in which it is accommodated in the respective shell. This facilitates the aforementioned preferred centering effect.

In principle, the edge of the shell may have any shape. It is advantageous in terms of manufacturing technology and makes good use of installation space that the edge of each shell preferably has a polygonal, preferably roughly rectangular or rectangular shape with preferably at least, particularly preferably exactly, four straight edge sections, of which respectively two run in pairs parallel to each other. As is typical for rectangular shapes, the different pairs of parallel edge sections together enclose a right angle. To avoid injury, the shape of the shell edge particularly preferably has rounded or beveled corners. This is what is meant by “roughly rectangular”.

The shell edges of upper shell and lower shell are preferably designed in complementary fashion so that the housing in the closed position securely encloses the housing volume and shields it from the surroundings. The respective shell edges of the upper shell and/or the lower shell are essentially planar. The shell edges of upper shell and lower shell are preferably planar over at least 75% of their circumferential length. Deviations may result for example due to the preferred design or arrangement of a hinge, which connects the upper shell and the lower shell in pivoting fashion relative to each other. To produce a mechanically particularly stable hinge, projections may be situated on the upper shell and on the lower shell respectively at a distance from one another in crenelated fashion, the projections of upper shell and lower shell being arranged offset relative to one another along their distanced direction so that the projections of upper shell and lower shell in the developed hinge are in meshing form-locking engagement with one another. A metal rod running along the distanced direction of the projections of upper shell and lower shell may then form a stable axle of the hinge.

The upper shell and/or the lower shell may be produced with advantageous constructional freedom in an injection molding process, for example from foamed polyurethane or from a styrene copolymer, valued because of its high impact resistance, such as an acrylonitrile butadiene styrene copolymer (ABS) or a blend of such an ABS copolymer and another plastic, such as polyamide or polycarbonate, for example. The plastic for forming the upper shell and/or the lower shell may be filled with particles and/or fibers, in particular glass fibers, in order to increase its strength.

The inner side of the upper shell and/or of the lower shell may have a mainly planar bottom in order to facilitate positioning the respective shell on a planar subsurface. This means that a portion of the inner surface and/or of the outer surface of the shell bottom has a planar design. The planar portion of the outer surface of the shell bottom may thus serve as a contact surface of the shell on a subsurface. Additionally or alternatively, the planar portion of the inner surface of the shell bottom may serve as a contact surface for supporting a bottom of an operating module. The mainly planar shell bottom is preferably inclined about an axis of inclination relative to the essentially planar edge of the shell. This makes it possible for a lateral wall, for example a lateral wall further removed from the machine operator in the functionally ready state of the operating module, to project further above the control panel of the operating module than a lateral wall that is closer to the machine operator and opposite to the more distant lateral wall. A certain glare protection of the control panel and its labeling or display areas may be achieved thereby.

Alternatively or additionally, the described inclination of the shell edge and shell bottom makes it possible to accommodate the control panel fully in the shell in a manner that is more inclined toward to the machine operator than the inclination of the support surface accommodating the housing on the operator platform or at another location of the earth working machine. This makes it possible to facilitate access to the control panel for the machine operator in the open position of the housing. The operating module is preferably situated in functionally ready fashion between the more remote lateral wall and the more proximate lateral wall.

To achieve the self-centering effect explained as advantageous above, in a preferred development of the present disclosure, the area of the bottom of the shell may be smaller than an area of the opening bordered by the edge of the shell. Nevertheless, due to the preferably mainly planar development of the bottom of the shell, a secure seating of the shell on a supporting subsurface and a secure attachment of the shell on the supporting subsurface may be ensured.

In order to provide the concavity of the inner side of the upper shell and of the lower shell, the lateral walls running from the edge of the shell to the bottom of the shell are inclined with respect to a perpendicular bisector onto an area of the opening bordered by the edge of the shell and/or with respect to a perpendicular bisector onto the area of the bottom of the shell. Preferably, mutually opposite lateral walls of the upper shell and the lower shell with respect to at least one of the mentioned perpendicular bisectors are inclined toward each other in the direction to the respective bottom as are the outer walls of the operating module running between the control panel and the operating module bottom.

The inclination of the lateral walls and/or of the outer walls may change once or multiple times in the course toward the respective bottom so that lateral walls and/or outer walls may be curved about axes of curvature or bent about bending axes at least in sections, wherein the axes of curvature or the bending axes may run for example in parallel or inclined to the respective bottom of the considered component of upper shell or lower shell on the one hand and the operating module on the other hand and/or in parallel to an edge of the respective shell on the one hand and the control panel on the other hand.

In principle, it shall not be precluded that the upper shell of the housing may be completely lifted off the lower shell and be releaseably positioned and anchored at a distance from the lower shell on a subsurface, prepared for this purpose, of a supporting area connected to the machine frame. Preferably, the upper shell is permanently connected to the lower shell in a captive manner. In a further development of this preferred embodiment, the upper shell and the lower shell are preferably pivotable relative to each other about a virtual pivot axis. Preferably, a pivot joint between the upper shell and the lower shell, for example the aforementioned hinge, forms a, particularly preferably the only, permanent connection between the two shells. The virtual pivot axis may be implemented by a physical pivot axle or by other connecting means known to one skilled in the art, which allow for a rotational degree of freedom of movement of the connected components.

In most cases, during its normal earth working operation, an earth working machine is moved in the forward direction along its roll axis in the longitudinal direction of the machine. This does not preclude a curved movement trajectory around a bend. The roll axis is then normally the tangent, or it is close to the tangent of the currently curved movement path of the earth working machine. For this reason, the operating module may be positioned on the earth working machine alternatively in the upper shell and in the lower shell in such a way that the operating module may be located at least also in the forward direction in front of the machine operator during the operation of the earth working machine. In this preferred arrangement, the reading direction of a possible labeling of operating elements on the control panel in Latin script runs in the transverse machine direction, that is, along the pitch axis of the earth working machine.

In this preferred arrangement of the operating apparatus, the virtual pivot axis between the upper shell and the lower shell runs in a plane which with a roll axis and/or a yaw axis of the earth working machine comprises an angle of no more than 30°, preferably of no more than 20°. The plane preferably runs parallel to the roll axis and parallel to the yaw axis. The virtual pivot axis, however, may be inclined about a reference axis that is orthogonal to the yaw axis and may approach the contact ground surface of the earth working machine along the roll axis.

Starting from the closed position, the upper shell and the lower shell are preferably pivotable by more than 90° in order to be able to ensure ergonomic access to the control panel of the operating module situated on one of the two shells. Preferably, the two shells are pivotable relative to each other by at least 160°, particularly preferably by at least 175°, and even more preferably between 178° and 182°.

In the specific embodiment described above, according to which the shell bottom and shell edge or the control panel and control module bottom are inclined relative to each other about an axis of inclination, the axis of inclination and the pivot axis preferably enclose an angle of 75° to 105°, particularly preferably of 85° to 95° and even more preferably a right angle.

The lower shell may be designed to be releasably connected to a carrier component, which supports the lower shell in the operationally ready state of the earth working machine. For this purpose, a latching mechanism may be formed on the carrier component and a counterpart latching mechanism may be formed on the lower shell, which can be brought into a releasable form-locking engagement. For example, one of the mentioned mechanisms may comprise a movable latch, which in a releasable form-locking engagement engages into a clearance of the respective other mechanism and may be removed from this clearance for releasing the form-locking engagement. The housing and thus the operating apparatus may then be removed from the rest of the earth working machine, if desired, and stored in a secure location while the machine is not in use.

Preferably, the lower shell is permanently connected to the carrier component, for example by screwing and/or riveting and/or bonding. While a screw connection is also designed to be releasable, the effort required to release the screw connection is chosen to be so high, due to the tool requirement and the duration of the tool engagement for releasing the screw connection, that a release of the screw connection will only occur in the context of a repair of the earth working machine.

The aforementioned intended releasability in contrast to a permanent connection of the lower shell to the carrier component preferably relates to a tool-less releasability or, in case a tool is required, a tool engagement of less than 15 seconds in order to release the lower shell from the carrier component.

The carrier component supporting the lower shell or the housing is connected to the machine frame. In principle, the carrier component may be connected permanently and rigidly to the machine frame. For further adaptation of an operator workstation of the earth working machine to the respective requirements of the machine operator as a function of the respective operating situation, the carrier component may be connected to the machine frame so as to be movable relative to it. The mobility of the carrier component, for example a tray, relative to the machine frame may be translatory, so that the machine operator is able to slide the operating module closer to himself or further away and/or that the machine operator is able to bring the operating module closer to a lateral edge of the earth working machine or move it away from the latter. Alternatively or additionally, the carrier component may be movable in rotary fashion relative to the machine frame, so that the machine operator is able to bring the control panel into an orientation that is respectively advantageous for his purpose.

In order to avoid unwanted noises or mechanical stresses, in the open position, the upper shell may be designed to be connected, in particular releasably connected, to a subsurface, for example to the aforementioned carrier component. For example, the upper shell may be connected to the carrier component in surmountable latching and/or magnetic fashion. In a particularly simple specific embodiment of the present disclosure, the upper shell may rest loosely on a subsurface in the open position.

For supplying the operating module with energy and/or for transmitting signals between the operating module and a data processing system of the control apparatus situated on the rest of the earth working machine outside of the operating apparatus, at least one shell of upper shell and lower shell may have an opening, through which an electrical connecting line to the operating module is routed in the operationally ready state. An opening in each of the shells may be provided if the operating module is to be connected directly to an energy source or to the data processing system of the control apparatus no matter in which of the shells the operating module is situated. An opening in only one of the shells may suffice if the operating module situated in the respective other shell is to be connected through the opening in the one shell to the energy source or the data processing system.

Establishing the connection of the operating module accommodated in the housing to the energy source and/or the data processing system of the control apparatus may be facilitated in that at least one shell of upper shell and lower shell comprises on its outer side an external electrical connection interface for the electrical connection to at least one on-board line of the earth working machine and comprises on its inner side an internal electrical connection interface connected to the external electrical connection interface in electrically conductive fashion for the electrical connection to the operating module. When the housing is situated on a subsurface, for example the aforementioned carrier component, the external electrical connection interface may be connected to the energy source and/or the data processing system via the at least one on-board line. The operating module situated in the shell having the internal electrical connection interface may be connected to the internal electrical connection interface in electrically conductive fashion.

Since the lower shell is preferably always connected to the subsurface regardless of whether the housing is in the open position or in the closed position, the external electrical connection interface is preferably provided on the lower shell. Preferably, an external electrical connection interface is provided both on the lower shell as well as on the upper shell, the external electrical connection interface of the upper shell preferably always being connected in electrically conductive fashion to an aforementioned on-board line when the housing is in the open position.

The operating module preferably comprises an electrical coupling formation for coupling to the electrical connecting line and/or a counterpart interface for coupling to the internal electrical connection interface.

If the operating apparatus is designed to be releasable from the carrier component and to be connectible to the latter, then the external electrical connection interface of the lower shell and/or a contact interface on the side of the carrier component preferably comprise(s) one or more electrical plug contacts or spring contacts so that the electrical contact between the external electrical connection interface and the contact interface on the side of the carrier component can be established without tools. One of the interfaces of the external electrical connection interface and the contact interface on the side of the carrier component is preferably designed as a plug and the respective other interface as a socket. In the event that an external electrical connection interface is situated on the upper shell, what was said about the connection interface of the lower shell also applies to the upper shell, respectively.

For the previously mentioned direct connection of the operating module to an on-board electrical connecting line, it is also the case that a connection of the on-board electrical connecting line to the coupling formation can preferably be established and secured without tools. For this purpose as well, one of the two components of the on-board electrical connecting line and the coupling formation may be or comprise a plug and the respective other component a socket, it being preferably possible to secure the plug and the socket to each other without tools in a form-locking manner against unintentional release, for example by a threaded coupling sleeve or a coupling sleeve with bayonet formation.

For securing the operating module on the shell selected to accommodate it, a preferred development may provide for each shell of upper shell and lower shell to comprise a fastening formation and for the operating element to comprise a counterpart fastening formation, wherein the fastening formation and the counterpart fastening formation can be brought into a releasably designed form-locking engagement for securing the operating module on a shell of upper shell and lower shell.

In a simple case, the fastening formation and the counterpart fastening may form a hook-and-loop fastener, by situating a fiber-loop crisscross as a fastening formation on one component of operating module and shell and by situating an elastic hook arrangement as the counterpart fastening formation on the respective other component.

A formation of fastening formation and counterpart fastening formation may comprise a projection, which engages into a clearance of the respective other formation of fastening formation and counterpart fastening formation for a form-locking engagement. The projection may be designed as a clip fastened on each end or as a projection protruding on one side. At least one formation of fastening formation and counterpart fastening formation may be displaceable between a form-locking engagement position and a release position in order to be able to release the established form-locking engagement as intended. The displacement between the form-locking engagement position and the release position may occur merely by the application of force. To prevent unauthorized removal of the operating module from a shell, the displacement may require the application of a locking secret, for example by a key, an alphanumeric code, a fingerprint, a file and the like.

The fastening formation and the counterpart fastening formation are preferably provided asymmetrically on their respective components: shell and operating module, so that the operating module is insertable into the respective shell only in a relative position relative to the upper shell or the lower shell and is securable there by a releasable form-locking engagement.

To facilitate the start-up of the earth working machine and in particular of the operating apparatus, it may be provided that at least one shell of upper shell and lower shell on the one hand and the operating module on the other hand are aligned with each other in such a way that when establishing the releasable form-locking engagement between the fastening formation of the respective shell and the counterpart fastening formation of the operating module, an electrically conductive connection is automatically established between the internal electrical connection interface of the respective shell and the counterpart interface of the operating module.

The complementary design of the inner side of the shell and the outer side of the operating module lying opposite the inner side of the shell in the operationally ready state, which was already described above, may contribute to such an alignment.

The alignment for the automatic establishment of the electrically conductive connection between the internal electrical connection interface and the counterpart interface may be effected at least partially also by a movement sequence, prescribed by the fastening formation and the counterpart fastening formation, of the relative movement of the operating module and the shell when positioning the operating module in the shell selected for positioning. Such a sequence may be achieved by a corresponding physical and/or kinematic design of the fastening formation and the counterpart fastening formation. In addition to the aforementioned elements of projection and clearance, of which at least one is displaceable between a form-locking engagement position and a release position for releasing a form-locking engagement established between them as intended, the fastening formation and the counterpart fastening formation may comprise a combination, formed on the shell and the operating module, of respectively fixed form-locking elements: projection and clearance, which are stationary relative to the structure of operating module and shell respectively supporting them. A movement sequence may then be determined in such a way that first the combination of stationary form-locking elements on the two components must be brought into mutual form-locking engagement and that this form-locking engagement then only leaves a degree of freedom of movement to bring the combination of releasable form-locking elements into the releasably designed form-locking engagement. For example, the combination of fixed form-locking elements may comprise at least two protruding projections on one component provided at a distance from each other and two clearances or recesses on the respective other component provided at the same distance from each other.

In principle, the operating module may comprise a data processing system, which is designed to process signals from sensors on the earth working machine and signals from operating inputs on the operating elements and to output control commands to actuators on the earth working machine.

The control apparatus of the earth working machine preferably also comprises at least one data processing system situated outside of the operating module and supported by the machine frame, to which the operating module can be connected for the transmission of signals. The operating module then serves more as an input module for inputting data and control commands. This reduces the costs of the operating module and facilitates the exchange of operating modules on the earth working machine for adaptation to changed working tasks or to new ergonomic findings.

The data processing system, whether it is situated in the operating module and/or outside of the operating module in the rest of the earth working machine, comprises at least one processor, such as a microprocessor for example, and at least one memory, in which at least one program, executable by the at least one processor, for controlling functional modules of the earth working machine is stored. The data processing system comprises at least one memory for storing data, such as sensor data, data based on actuating one or more of the operating elements of the control panel, data for executing the at least one program, for example. The earth working machine may comprise at least one or multiple sensors connected to the data processing system in signal-transmitting fashion, which record the operation of the earth working machine, such as its travel speed, positions and states of actuators, steering angles of traveling gear components, a spatial arrangement and/or orientation of components of the earth working apparatus, possible movement speeds and/or movement directions of components of the earth working machine and the like.

For the feedback of operating states to the machine operator, the operating module preferably comprises at least one output apparatus for outputting signals and/or data. Such an output apparatus may comprise a monitor, in particular a touchscreen that can also be used as an input apparatus, a loudspeaker, a signal lamp, a haptic output apparatus, such as a vibrator, and the like. Thus, the operating module is able to output data from the data processing system, regardless of its location, to the machine operator.

The housing has at least two shells, an upper shell and a lower shell. The housing is therefore able permanently to accommodate at least two operating modules simultaneously. Thus, it is possible on the one hand to situate a module either in the one or in the other shell. For an expanded functional scope, the aforementioned operating module may be a first operating module, the control apparatus comprising a second operating module in addition to the first operating module. Each operating module of the first and second operating module can then be preferably positioned functionally ready in each shell of upper shell and lower shell and in the operationally ready state of the earth working machine is also actually so positioned. When an operating module is described herein as being capable of being positioned on each of the upper shell and the lower shell it will be understood that this means the operating module may be positioned on one shell or the other at any given time; it is not required that the operating module be positioned on both shells at the same time.

What was said above regarding the operating module or regarding the first operating module applies in the same way to the second operating module. In particular, the electrical coupling formations of the first and of the second operating modules are designed identically. Since the internal electrical interfaces of the upper shell and the lower shell are also designed identically, one is free to choose to position the first and the second operating module in the lower shell or in the upper shell. The control panel of the second operating module differs preferably from the control panel of the second operating module in regards to the kind of operating elements situated there and/or the arrangement of the operating elements and/or the functional assignment of operating elements so as to provide the machine operator with different functions on the two operating modules and to indicate to the machine operator at first glance on which of the two operating modules he is presently working.

In principle, it may suffice if the housing comprises exactly one upper shell and one lower shell. A greater space, which may be fitted locally with at least one operating module, may be provided on the earth working machine, however, in that the housing comprises, in addition to the upper shell, a second upper shell and/or, in addition to the lower shell, a second lower shell. The housing preferably comprises more upper shells than lower shells since the lower shell is preferably firmly connected to a subsurface at least during the operation of the earth working machine. A specific embodiment having one lower shell and two upper shells is therefore particularly preferred. The upper shells are preferably developed with identical upper shell volumes, particularly preferably as identical parts or as components designed in mirror symmetry.

In the event that the housing comprises, in addition to the upper shell, a second upper shell, the second upper shell and the lower shell are preferably pivotable relative to each other about a second virtual pivot axis. Preferably, each virtual pivot axis is implemented for a relative pivot of an upper shell relative to the lower shell both on a straight edge of the lower shell as well as of the upper shell. In order to be able to position the at least one operating module on a shell in the greatest possible range on the earth working machine, when two upper shells are arranged, then the virtual pivot axis and the second virtual pivot axis are preferably developed on opposite edges of the lower shell.

The two upper shells and the lower shell may surround a workstation of a machine operator on the earth working machine in a curved and ergonomically advantageous manner if the second virtual pivot axis together with the first virtual pivot axis encloses an angle. This angle, however, should preferably not be greater than 30°. In the open state of the housing, the sequence from one end region of the housing across the two virtual pivot axes to the other end region of the housing is then: upper shell-lower shell-second upper shell.

In earth working machines that are presently of particular interest, such as slipform pavers for example, the operator platforms normally extend in a straight line in the transverse machine direction. Particularly preferably, therefore, the second pivot axis is oriented in parallel to the first pivot axis. The housing is preferably designed in mirror symmetry with respect to a plane of symmetry. The plane of symmetry runs in this instance orthogonally to a bottom of the lower shell as a bisector or as a parallel to the two virtual pivot axes, which define the two upper shells with the common lower shell.

The present disclosure may be applied particularly advantageously on a slipform paver.

### BRIEF DESCRIPTION OF THE DRAWINGS

The present disclosure is explained in greater detail below with reference to the enclosed drawings. The figures show:

FIG. 1 a schematic perspective view of an earth working machine according to the disclosure in the exemplary form of a slipform paver at an angle from behind and above,

FIG. 2 a schematic perspective view of the operator platform of the earth working machine from FIG. 1 with the housings of the control apparatus in the open position,

FIG. 3 a schematic perspective view of the operator platform from FIG. 2 with the housings of the control apparatus in the closed position,

FIG. 4 a schematic perspective view of the housing of FIGS. 1 and 2 equipped with operating modules,

FIG. 5 a schematic perspective view of the housing from FIG. 4 with a view of the front side of the housing,

FIG. 6 a schematic perspective view of the housing from FIG. 5 between the open position and the closed position,

FIG. 7 a schematic perspective view of the operating modules situated in the housing of FIGS. 4 through 6,

FIG. 8 a view corresponding to the perspective of FIG. 4 of the housing from FIG. 4 without operating modules, and

FIG. 9 a schematic bottom view of the housing from FIG. 4.

### DETAILED DESCRIPTION

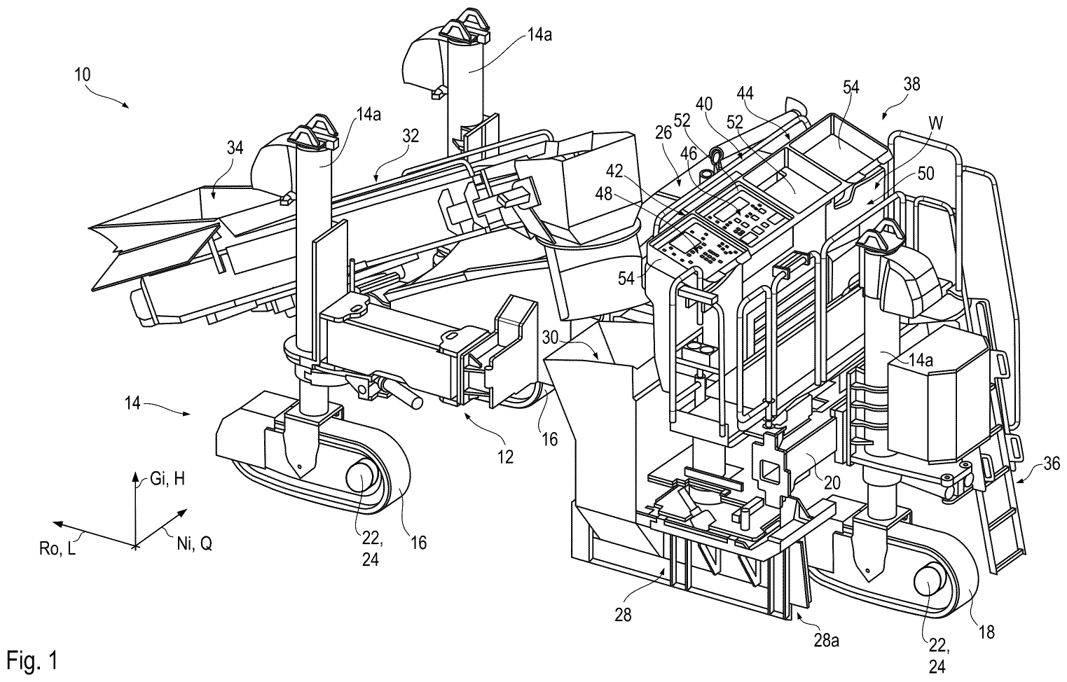

FIG. 1 shows schematically a specific embodiment according to the present disclosure of an earth working machine 10 (subsequently also referred to merely as “machine 10”) in the form of a slipform paver. Machine 10 comprises a machine frame 12, which is supported by a traveling gear 14. The traveling gear 14 comprises a plurality of drive units, which are able to roll off on a contact ground surface. In the illustrated example, the drive units are crawler track units having revolving crawler tracks. At least one or all of the drive units may be roller or wheel drive units. In the illustrated example, the traveling gear 14 comprises two front drive units 16 and one rear drive unit 18. In place of this configuration, two rear drive units may also be provided. The rear drive unit 18 may be positioned by a corresponding motor actuator along a drive unit carrier 20 in and counter to the transverse machine direction Q along the pitch axis Ni.

Each of the drive units 16 and 18 has in a manner known per se a hydraulic motor 22 as the travel drive 24. A combustion engine 26, more precisely a Diesel combustion engine 26 provides, as a power plant of machine 10, as it were, the energy required for operating the machine 10. Required energy is derived from the rotating crankshaft of combustion engine 26 in order to provide, in addition to the kinetic energy of the crankshaft, hydraulic energy via hydraulic pumps for hydraulic actuators and consumers, such as hydraulic motors and piston-cylinder systems, electrical energy via a generator for electrical consumers including a rechargeable electrical energy store and in order to provide optionally, via pneumatic compressors, pneumatic pressure for pneumatic actuators and consumers.

Via lifting columns 14a of traveling gear 14, the distance of the machine frame 10 from the contact ground surface of machine 10 is individually adjustable for each drive unit along the yaw axis Gi running parallel to the vertical machine direction H.

As the earth working apparatus, a slipform 28 known per se for forming a concrete mold is situated on machine frame 12, merely by way of example on its left machine edge in FIG. 1. The slipform 28 is charged with free-flowing concrete via a funnel 30. Via a conveyor belt 32, the funnel 30 is supplied with free-flowing concrete, which the conveyor belt 32 conveys from a receiving bunker 34 in the front end region of machine 10 to the funnel 30.

Together with the contact ground surface of machine 10, the slipform 28 forms a mold cavity, in which the free-flowing concrete flowing from the funnel 30 into the cavity is molded in a manner known per se as a positive image of the mold wall that surrounds the mold cavity in the circumferential direction about the roll axis Ro running parallel to the longitudinal machine direction L and that acts as a negative form. At the latest at the outlet 28a of the slipform 28, the free-flowing concrete is fixed relative to the contact ground surface contributing to its molding and in the operation of machine 10 emerges at the rear end of the slipform 28, when viewed in a slipform-fixed coordinate system, at a speed corresponding to the travel speed and thus the feed rate of machine 10 in terms of absolute value but in the opposite direction of the machine travel. The feed rate of the machine 10 and the concrete mixture output through the slipform 28 are to be coordinated in such a way that the concrete sets in a dimensionally stable manner between its entry into and its exit from the slipform 28 so that it maintains its received form upon exiting from the slipform 28.

Machine 10 comprises an operator platform 38 reachable from the contact ground surface via steps 36, which operator platform extends along the pitch axis Ni over essentially the entire width of machine 10. In contrast to the illustration of FIG. 1, the slipform 28 may also be attached on the opposite right edge of the machine. A machine operator working on the operator platform 38 spends a substantial portion of his work time on the operator platform 38 observing the molded concrete emerging from the slipform 28. For this reason, the machine operator stays mainly in the end region of the operator platform 38 closest to the slipform 28.

For controlling the machine 10, a control apparatus 40 is situated on the operator platform 38, which comprises two housings 42 and 44 as well as two operating modules 46 and 48.

The two housings 42 and 44 are arranged side by side along the pitch axis Ni and are designed in mirror image with regard to a plane of symmetry that is orthogonal to pitch axis Ni. In consideration of the mentioned mirror symmetry, it suffices to describe below the housing 42, the description of which also applies to housing 44 when taking the condition of symmetry into account.

Each of the housings 42 and 44 from FIG. 1 comprises a lower shell 52 firmly connected to a console 50 as a carrier component and an upper shell 54 pivotable about a pivot axis P relative to the lower shell 52. Due to the mirror-symmetrical design of the housings 42 and 44, in their open position, their lower shells 52 are directly next to each other along the pitch axis Ni and between their upper shells 54.

In FIG. 1, both housings 42 and 44 are shown in their respective open position. The operating modules 46 and 48 are here located only in housing 42, the operating module 46 being located in the lower shell 52 and the operating module 48 being located in the upper shell 54 of housing 42.

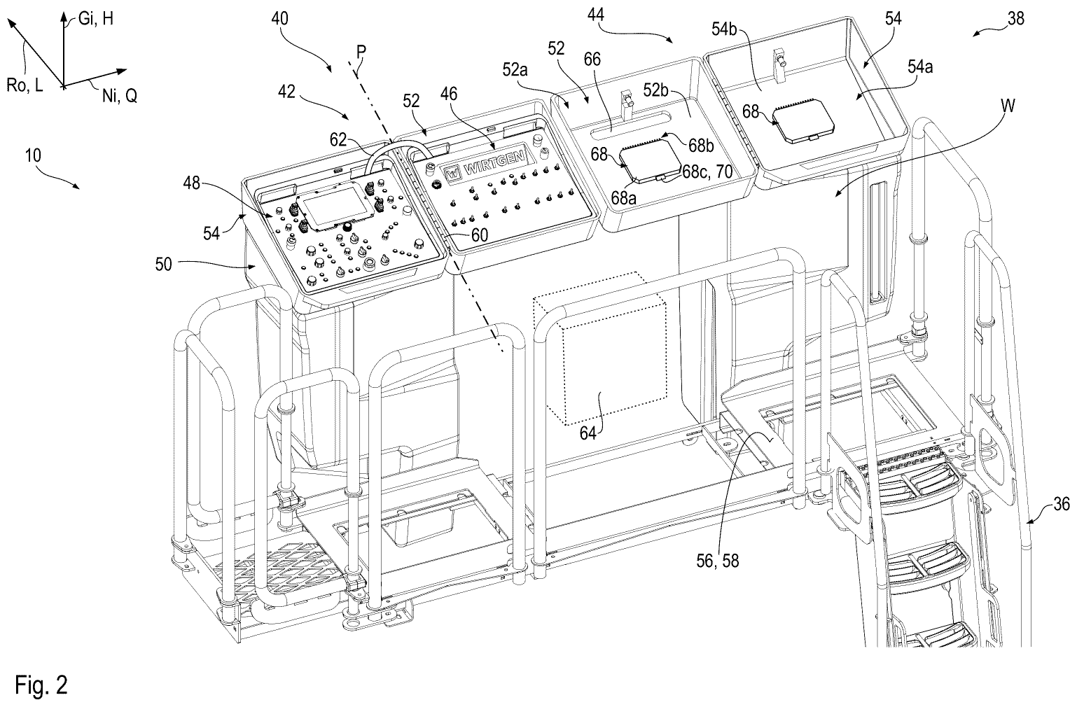

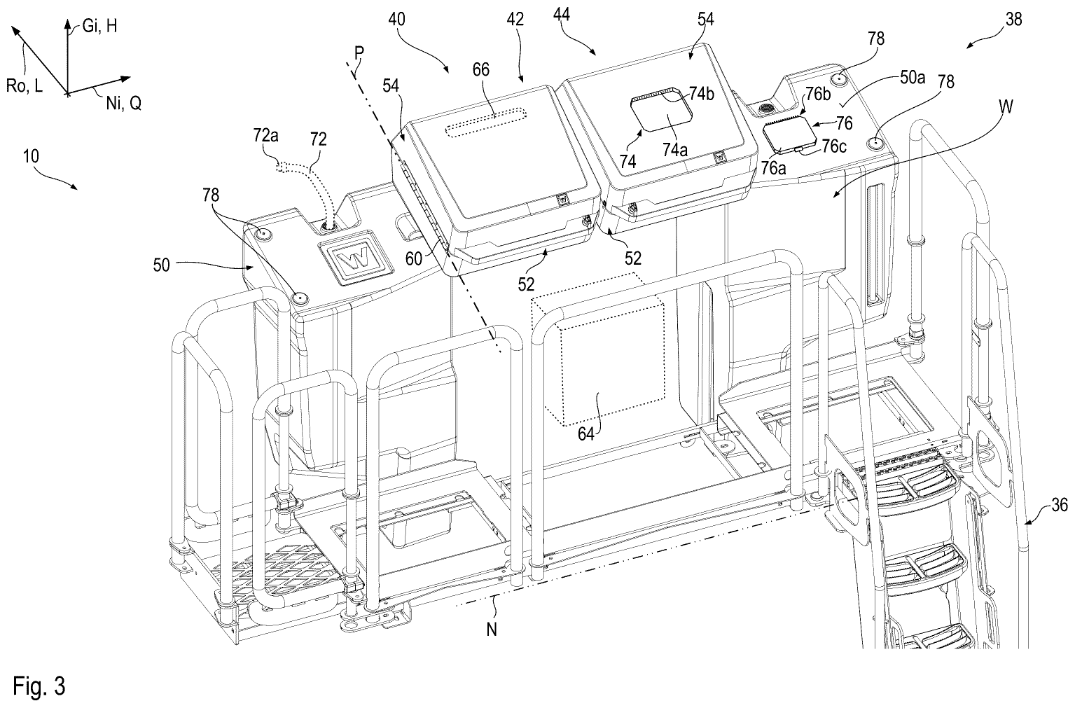

FIG. 2 shows the operator platform 38 with its steps 36 in isolation, the housings 42 and 44 being again in their respective open position. FIG. 3 shows the operator platform 38 with its steps 36 in the same perspective as FIG. 2, but with the housings 42 and 44 in the closed position.

In FIGS. 2 and 3, a frame 56 is illustrated as part of the operator platform floor 58, which in FIG. 1 is seen in its entirety. The machine operator is located on this operator platform floor 58 during his activity of controlling a normal operation of the earth working machine 10.

The upper shells 54 and the lower shells 52 are pivotable relative to each other by approximately 180° about the pivot axis P between the closed position shown in FIG. 3 and the open position shown in FIG. 2. For greater clarity, only the pivot axis P at the hinge 60 of the housing 42 connecting the upper shell 54 with the lower shell 52 is illustrated. The pivot axis P lies in a plane extending parallel to the plane spanned by the yaw axis Gi and the roll axis Ro. In the illustrated preferred exemplary embodiment, however, the pivot axis P is neither parallel to the roll axis Ro nor to the yaw axis Gi.

With housing 44 unoccupied by operating modules, FIG. 2 shows the inner side 52a of lower shell 52 that is concave with regard to each of two spatial directions that are orthogonal to each other and the inner side 54a of upper shell 54 that is concave with regard to each of two spatial directions that are orthogonal to each other. With housing 44, FIG. 2 shows a possible development of the lower shell 52 and the upper shell 54 that also applies to housing 42.

The operating module 48 in FIG. 2 may be connected to the operating module 46 by a connecting cable 62 transmitting signals and energy. The operating module 46 is then the only operating module that is connected to an on-board energy supply of the machine 10 and possibly to a data processing system 64 of machine 10. The data processing system 64 may be situated in console 50 of the operator platform 38 or may be situated at another suitable location in machine 10.

The signal and energy-transmitting connection of an operating module to on-board components of the machine 10 may be implemented by way of a cable connection. For this purpose, as for example in the lower shell 52 of housing 44, a hole 66 through the lower shell 52 may be configured as a cable bushing. Additionally or alternatively, on the concave inner side 52a of the lower shell 52, in particular on the inner side of the shell bottom 52b, an internal electrical connection interface 68 may be developed, which automatically establishes a signal and energy-transmitting connection of the operating module with on-board components of machine 10 when an operating module is positioned in the lower shell 52. The shell bottom of the upper shell 54 is accordingly labeled 54b. As described below, the internal electrical connection interface 68 is also an internal mechanical connection interface.

The merely schematically illustrated internal electrical connection interface 68 may have a physical structure 68a that protrudes away from the shell bottom 52b. The operating module may have on its operating module bottom a corresponding complementary clearance as part of a counterpart interface on the side of the operating module. When positioning the operating module in the lower shell 52 or in the upper shell 54, which may have an identical internal electrical connection interface 68 so as to ensure that an operating module may be positioned in both shells 52 and 54, the physical projection 68a of the internal electrical connection interface 68 protrudes into the clearance of the counterpart interface on the side of the operating module. The assignment of the projection and the clearance may of course be chosen differently from the illustrated example. To ensure that an operating module 46 or 48 may be set down on another level surface than a shell bottom of lower shell 52 or upper shell 54 without tipping and without wobbling, the physical structure 68a is preferably developed in the internal electrical connection interface 68 of the shells 52 and 54 and a clearance corresponding to the structure and receiving this structure is preferably developed in the counterpart interface of the operating modules 46 and 48.

The internal electrical connection interface 68 comprises a contact configuration 68b, for example a spring contact strip, which contacts a counterpart contact configuration on the side of the operating module when connecting the internal electrical connection interface 68 to a counterpart interface of the operating module due to the complementary design of the connection interface 68 and the counterpart interface.

A spring-loaded latch 68c may engage in a corresponding latch clearance in the counterpart interface of the operating module and thus secure the operating module on the respective shell in form-locking fashion. The spring-loaded latch 68c is part of a fastening formation 70, the latch clearance then being part of a counterpart fastening formation on the side of the operating module. By way of an actuator not shown in the figures, the latch 68c is retractable into the physical structure 68a of the internal electrical connection interface 68 in order to release an established physical connection between the respective shell and an operating module. The actuator may be operable by motor or manually, for example by a lever linkage.

In FIG. 3, housings 42 and 44 are illustrated in the closed position, in which they completely enclose the operating modules accommodated therein or the inner chamber surrounded by the concave inner sides 52a and 54a.

FIG. 3 indicates merely by a dashed line that the upper shell 54 of the housing 42 may have a hole 66 as a cable bushing in order to connect, in contrast to the illustration of FIG. 2, an on-board connecting line 72 routed through the console 50 with the operating module 48 accommodated in the upper shell 54 in signal and energy-transmitting fashion. The plug 72a on the free longitudinal end of the on-board connecting line 72 forms a first on-board interface for connecting an operating module 46 or 48 to an on-board energy supply and/or to the on-board data processing system 64 of the machine 10.

On the outer side of the operating module bottom 54b of the upper shell 54 of the housing 44 in FIG. 3, an external electrical connection interface 74 is shown, which has a recess or clearance 74a in the operating module bottom 54b on its outer side. The external electrical connection interface 74 is in principle constructed like the counterpart interface of the operating module described above, for the external electrical connection interface 74 is designed for the mechanical and electrical coupling with a second on-board interface 76 on the subsurface 50a, covered in the open state of the housing 44, of the console serving as the carrier component in the same way as the counterpart interface of the operating module for the mechanical and electrical coupling with the internal electrical connection interface 68.

The external electrical connection interface 74, which like the previously described internal electrical connection interface 68 is also an external mechanical connection interface, on the outer side of the operating module bottom 54b is designed to be smaller than the internal electrical connection interface 68 on the inner side of the same operating module bottom 54b and is entirely overlapped by the larger area internal electrical connection interface 68. An electrical counterpart contact configuration 74b on the external connection interface 74 is used for electrical contact by a contact configuration 76b on the physical structure 76a of the second on-board interface 76. A spring-loaded latch 76c shown in the protruding position in FIG. 3 serves for the temporary form-locking fixation of the upper shell 54 over the subsurface 50a in the open position of the housing 44.

The contacts of the counterpart contact configuration 74b are connected directly to the contacts of the contact configuration 68b on the inner side of the upper shell 54. Hence, when the upper shell 54 is in the normal latching engagement with the second on-board interface 76 via its external electrical connection interface 74, an operating module situated on the concave inner side 54a of the upper shell 54 is then electrically connected to an on-board energy supply and to the on-board data processing system 64 of the machine 10 via its contact configuration in its counterpart interface, the contact configuration 68b of the internal electrical connection interface 68 of the upper shell 54, the counterpart contact configuration 74b of the external electrical connection interface 74 of the upper shell 54 and the counterpart contact configuration 76b of the second on-board interface.

With the exception of the smaller dimensions, the second on-board interface 76 is designed like the internal electrical connection interface 68, the description of which is therefore also applicable to the second on-board interface 76, the number 68 merely having to be replaced by the number 76. The physical structure 76a is developed to be complementary to the clearance 74a of the external electrical connection interface 74 and in the open position of the housing 44 protrudes into the clearance 74a of the upper shell 54.

In the open position, the upper shell 54 of the housing 42 equipped in the exemplary embodiment with operating modules 46 and 48 merely rests unlocked on bump stops 78 on console 50. The varied illustrations of the design of the housings 42 and 44 in the exemplary embodiment merely serves for information about fundamentally possible specific embodiments. Normally, the housings 42 and 44 will be designed identically within the scope of the aforementioned mirror-symmetrical development.

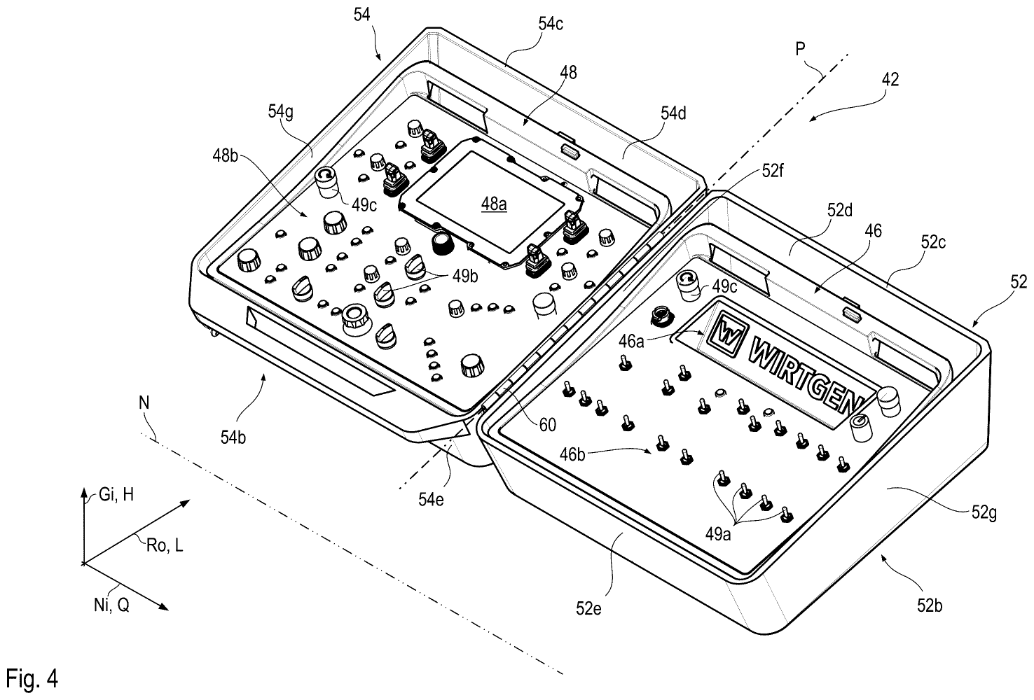

In FIG. 4, the housing 42 is shown in isolation with the operating modules 46 and 48 accommodated therein. The operating modules 46 and 48 each have a display apparatus 46a and 48a, respectively, for displaying data and for outputting information. The display apparatuses 46a and 48a are constructed differently and are used in operation for different visual information outputs. Furthermore, each operating module 46 and 48 has its own control panel 46b and 48b with operating elements individually arranged thereon, see for example operating elements such as rocker switch 49a, push button switch 49b and rotary switch 49c. The control panels 46b and 48b have an identical total surface area. The operating elements of the two control panels 46b and 48b differ with regard to their arrangement on the control panel as well as with regard to their manner of functioning and actuation. While mainly rocker switches 49a and only a few rotary switches 49c and push button switches 49b are situated on control panel 46b, rotary switches 49c and push button switches 49b predominate on control panel 48b.

In principle, the control panels 46b and 48b may be designed for controlling different machine functions. For example, one of the operating modules 46 or 48 may be used to control the concrete equipment, comprising inter alia the material conveyance, trough control, vibrator, and the like, and the respective other operating module 48 or 46 may be used to control the components of the machine kinematics, comprising inter alia the travel drive 24, a height adjustment by lifting columns 14a, a steering positioning of the drive units 16 and 18. There may also be functions that are controllable on each of the operating modules 46 and 48.

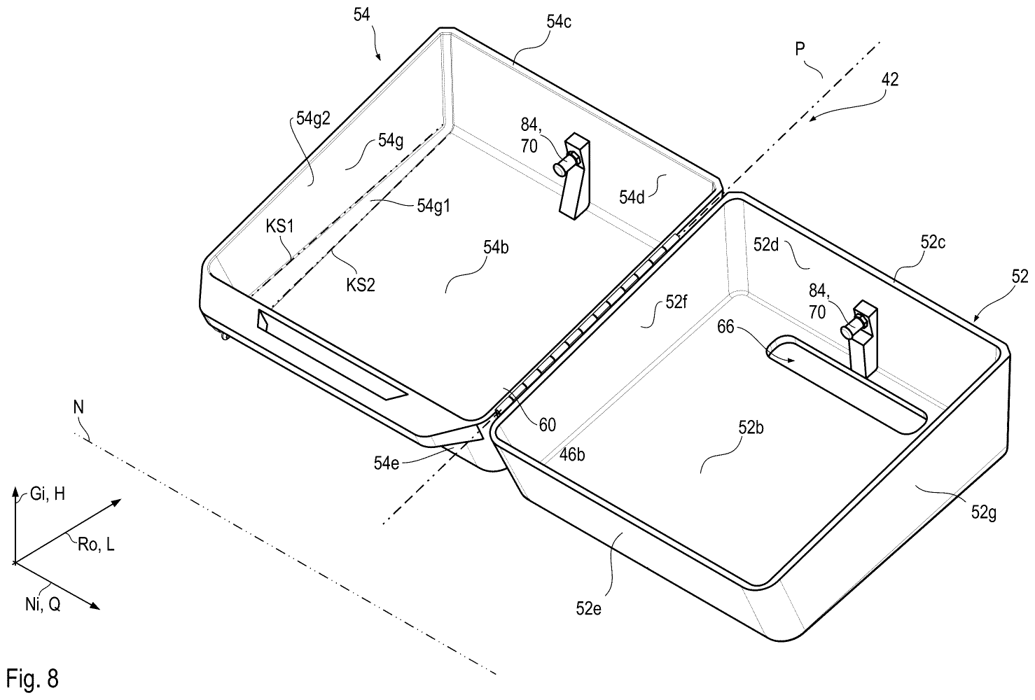

The control panels 46b and 48b, on which the operating elements are mounted, are essentially planar and are oriented in the illustrated example parallel to the bottom 46c and 48c of the operating modules 46 and 48, respectively (see also FIG. 8).

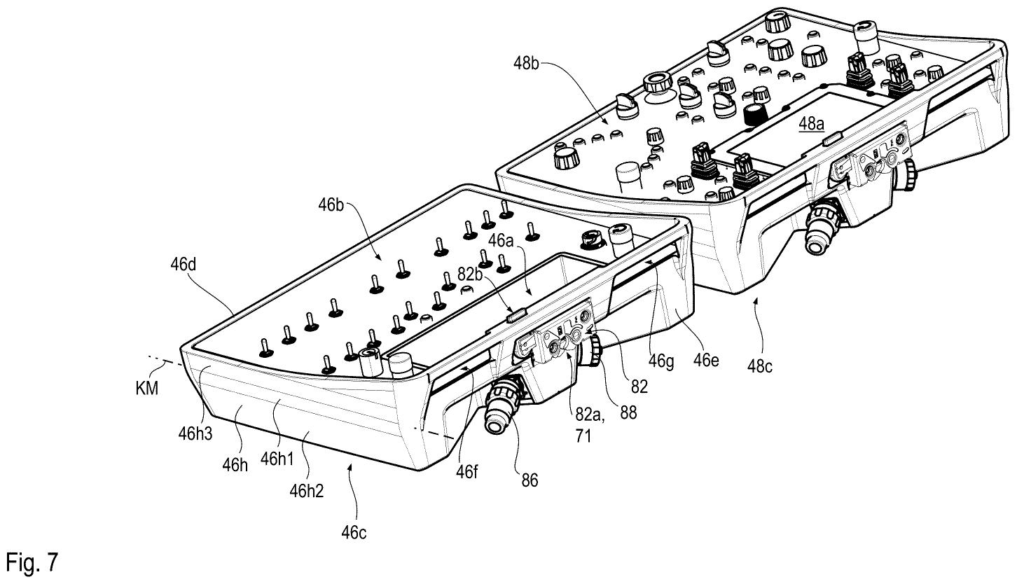

The upper shell 52 and the lower shell 54 are bounded by shell edges 52c and 54c, respectively, which abut against each other in planar fashion in the closed position of the housings. The shell edges 52c and 54c are respectively planar shell edges, i.e., they lie respectively in a plane. In the open position of their housing 42 and/or 46, the shell edges 52c and 54c are preferably coplanar, as is the case in FIGS. 4 and 7.

As can be seen in FIGS. 4 and 7, the plane of the shell edges 52c and 54c is inclined about an axis of inclination N with regard to the plane of the associated shell bottoms 52b and 54b. In the operationally ready state of the housings 42 and 44 arranged on the operator platform 38, the axis of inclination N preferably runs parallel to the pitch axis Ni on the side of housings 42 and 44, on which the workspace W (see FIGS. 2 and 3) of the machine operator is also located. In the illustration of FIGS. 4 and 7, the axis of inclination N is shown to be closer to housing 42 than is actually the case. FIG. 3 shows a more realistic position of the axis of inclination N relative to the housings 42 and 44.

Thus, the lateral walls 52d and 54d of the lower shell 52 and of the upper shell 54, respectively, which are further removed from the machine operator and run along the pitch axis Ni, protrude further from the respective shell bottom 52b and 54b, respectively, upward than the lateral walls 52e and 54e, which are closer to the machine operator and likewise run along the pitch axis Ni. Accordingly, the lateral walls 52d and 54d situated further away from the machine operator project further above the control panels 46b and 48b of the operating modules 46 and 48 accommodated in the respective shells 52 and 54 than the lateral walls 52e and 54e situated closer to the machine operator. A certain glare protection may thus be achieved for the control panels 46b and 48b with respect to light sources situated in front of the machine 10. In addition, the housing 42 may thus be closed without operating elements protruding from the respective control panels 46a and 48b colliding with one another or with the control panel of the respective other operating module.

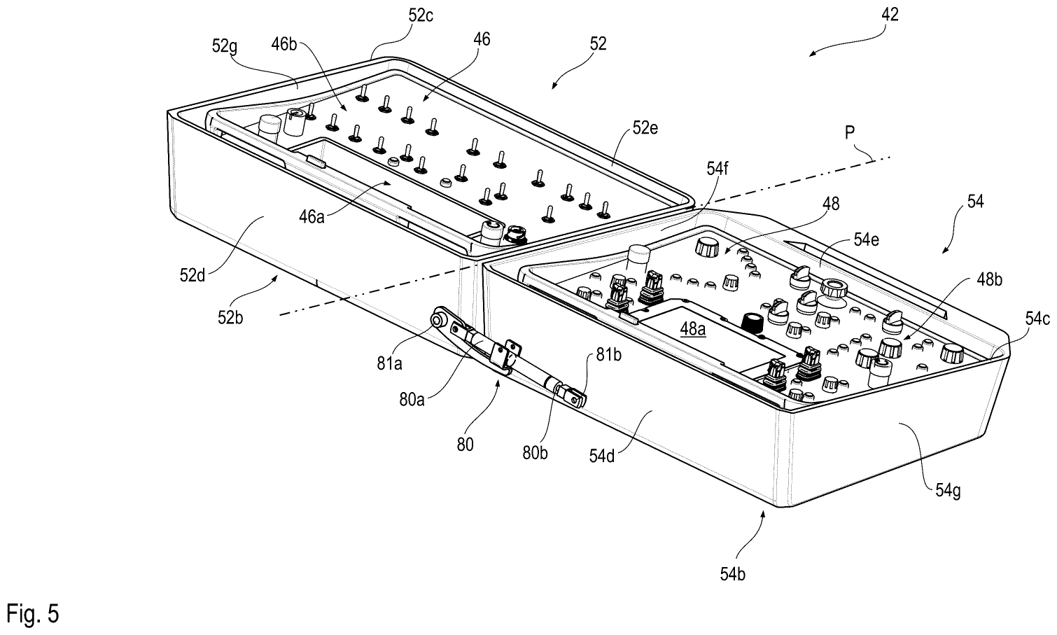

FIG. 5 shows the same arrangement as FIG. 4, but at an angle from the front. In FIG. 5, a shock absorber 80 is shown on the outer side of lateral walls 52d and 54d, which connects the two shells 52 and 54 to each other at its linkage points 81a and 81b, and which limits the pivot speed of the pivot movement of the shells 52 and 54 relative to each other in order to prevent the upper shell fitted with the operating module 48 from striking the bump stops 78 at high speed and there being extremely decelerated with great dynamic effect. This makes it possible to protect the electronics in the operating module 48 against unwanted damage through shocks when opening the housing 42. The shock absorber 80 may be a fluid shock absorber known per se, for example an overrun shock absorber, which limits a relative velocity between a cylinder 80a and the piston rod 80b protruding from it in that a viscous fluid flows through openings in the piston accommodated in the interior of its cylinder 80a. For flow resistances grow approximately quadratically with the flow velocity at the obstacle to the flow so that the braking effect exerted by the shock absorber 80 on the housing shells 52 and 54 progressively increases with increasing relative pivot velocity of the two housing shells 52 and 54.

The lateral walls 52f and 52g of the lower shell 52 lying opposite each other along the pitch axis Ni and the lateral walls 54f and 54g of the upper shell lying opposite each other along the pitch axis Ni connect the lateral walls 52d and 52e and the lateral walls 54d and 54e, respectively, with one another. The lateral walls marked by “f” are directly connected by the hinge 60. In the closed position of the housing 42, lateral walls of the upper shell and of the lower shell marked by the same lower-case letter connect to one another across their respective lateral edges marked by the lower-case letter “c”.

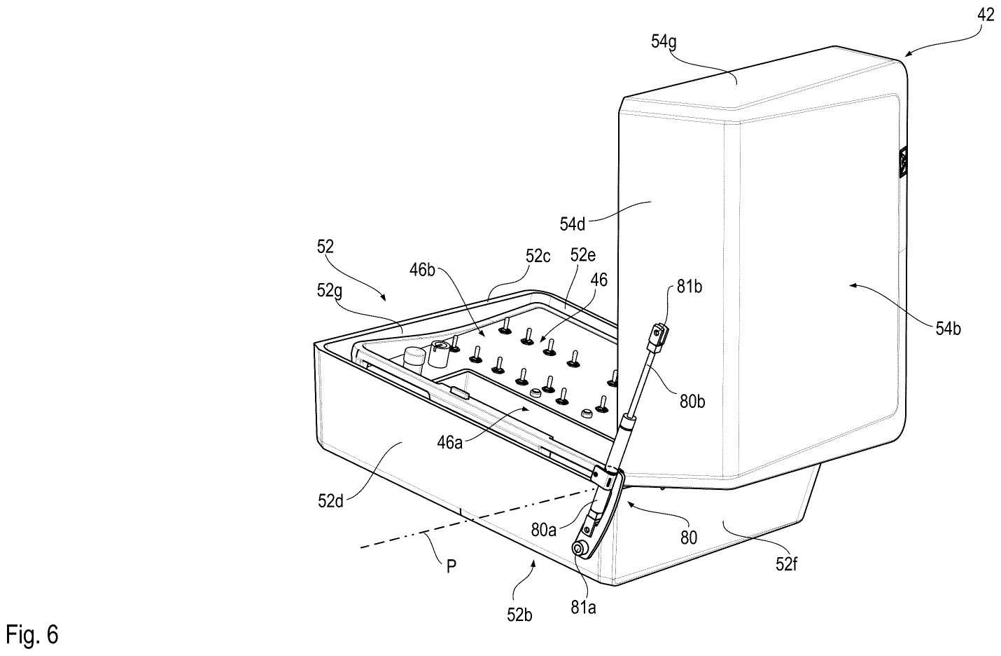

In FIG. 6, the housing 42 from FIG. 5 is shown in a half-open position between the open position and the closed position.

In FIG. 7, the operating modules 46 and 48 are shown without the housing 42. The operating modules 46 and 48 have an essentially identical outer shape, and essentially identical interfaces, which is why it presently suffices to describe only one of the operating modules 46 and 48, since their description, with the exception of the respectively varying control panels 46b and 48b, also applies to the respective other operating module.

The operating module 46 has an edge 46d, from which the outer walls of the operating module 46, see for example the outer walls 46e and 46h, extend toward the bottom 46c of the operating module 46. The outer walls of the operating module 46 enclose electrical components situated below the control panel 46a. They connect directly to control panel 46a. In the illustrated exemplary embodiment, the edge 46d is located in the region of the operating module 46 located in operation closer to the machine operator, at the same elevation as the control panel 46b. In the region of the operating module 46 that is situated in operation further away from the machine operator, the edge 46d is provided projecting above the control panel 46b at a distance from control panel 46b so that on the outer wall 46e of the operating module 46 facing away in operation from the machine operator along the roll axis Ro handle clearances 46f and 46g may be developed, which facilitate inserting the operating module 46 into one of shells 52 and 54 and facilitate the removal of the operating module 46 from the respective shell.

The outer shape of the operating module 46 tapers from edge 46d toward bottom 46c so that the outer shape of the operating module 46 has a roughly convex outer shape, which fits into the concave inner sides 52a and 54a of the shells 52 and 54, respectively. In order to be able to provide a convex outer shape, the lateral outer wall 46h for example has a curved section 46h1, which is designed to be curved about an axis of curvature KM. Due to the convex outer shape of the operating module 46, the area of the bottom 46c of the operating module 46 is smaller than the area of the control panel 46b.

The lateral outer wall sections 46h2 and 46h3 below and above the curved section 46h1 are essentially planar and are inclined relative to each other about the axis of curvature KM due to the curved section 46h1 situated between them.

A latching mechanism 82 having a latch claw configuration 82a as part of a counterpart fastening formation 71 is situated on outer wall 46e. Via a push-button 82b, the latch claw configuration 82a may be brought into a release position, in which it releases a latching pin 84 shown in FIG. 8 as part of the fastening formation 70. The latch claw configuration 82a is set, for example by an over-dead-center kinematics, in such a way that when the latching pin 84 is inserted into the latch claw configuration 82a it is displaced by the latching pin 84 into a form-locking engagement position embracing the latching pin 84 and remains there until the push-button 82b is actuated. Alternatively or in addition to the connection interface 68 described above, the operating module 46 can thus be mechanically secured by form-locking engagement in a shell of lower shell 52 and upper shell 54 by the latching mechanism 82 and the latching pin 84.

By way of example, the latching pin 84 protrudes from each of the lateral walls 52d and 54d toward the respectively opposite lateral wall 52e and 54e. Due to this asymmetrical arrangement, an operating module may be situated in one of the shells 52 and 54 only in exactly one relative position.

In order to provide a concave inner side, the lateral walls of the housing shells 52 and 54 are also inclined and together with the bottom 52b and 54b, respectively, enclose an angle of more than 90°.

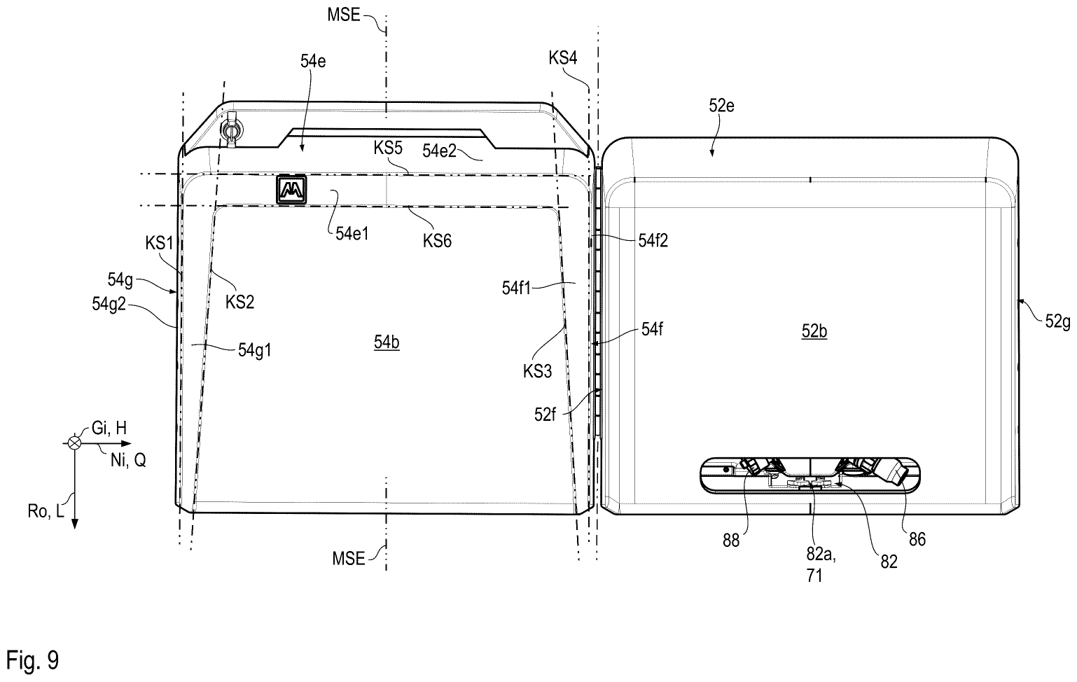

FIGS. 8 and 9 show bending axes KS1 through KS6, about which adjacent sections of the lateral walls of the upper shell 54 situated on both sides of a respective bending axis are angled relative to each other. The bending axes KS1, KS2, KS5 and KS6 running along the lateral walls 54f and 54g are developed on shell bottom 54b in mirror symmetry with respect to a perpendicular bisector plane MSE orthogonal to the drawing plane of FIG. 9 and are inclined toward one another. This is merely an exemplary embodiment, however. The bending axes KSM3 and KSM4 associated with the lateral wall 54e, in contrast, are parallel to one another and in the operationally ready state parallel to pitch axis Ni. The lateral wall sections 54e1, 54f1 and 54g1 situated closer to the shell bottom 54b are less inclined with respect to the shell bottom 54b than the more distant lateral wall sections 54e2, 54f2 and 54g2 of the same respective lateral walls 54e, 54f and 54g.

In the area near the shell bottom 52b of the lower shell 52, the lateral walls 52e, 52f and 52g of the lower shell 52 are developed differently than the corresponding lateral walls of the upper shell 54. Nevertheless, the lateral walls 52e, 52f and 52g have the same angle of inclination relative to the shell bottom 52b of the lower shell 52 as the respective lateral edge sections 54e1, 54f1 and 54g1 of the corresponding lateral walls of the upper shell 54. The same applies to the lateral walls 52d and 54d not shown in FIGS. 8 and 9. This ensures that sections of the outer walls of the operating modules 46 and 48 abut against inner sections of the lateral walls 52d, 52e, 52f and 52g as well as 54d, 54e, 54f and 54g with only a small gap or preferably without play.

As shown in FIG. 7, the operating modules 46 and 48 may comprise, in addition or as an alternative to the counterpart interface, which couples with the internal electrical connection interface 68, a coupling formation 86, which may be coupled to a plug 72a of an on-board connecting line 72 in order to supply the coupled operating module with electrical energy and to ensure signal transmission with the on-board data processing system 64. The coupling formation 86 is designed for quick coupling with plug 72a on the on-board connecting line 72. The plug 72a may be secured in form-locking fashion on coupling formation 86 by a bayonet catch or a screw cap.

The operating modules further comprise a forwarding interface 88, via which a further operating module may be connected, via a connecting cable 62, as shown in FIG. 2, to an operating module directly connected to the on-board connecting line 72, for electrical energy supply and for signal transmission. The connecting cable 62 may be connected with one end to the forwarding interface 88 of the one operating module and with the other end to the coupling formation 86 of the other operating module. The forwarding interface 88 is also a quick coupling interface having, for example, a bayonet or screw cap lock for securing an electrical connection once it is established.

1-15. (canceled)

16. A self-propelled earth working machine, comprising:
a machine frame:
a plurality of wheels or tracks configured to support the machine frame from a ground surface;
a travel drive configured to drive at least one of the wheels or tracks to propel the earth working machine;
an earth working apparatus supported by the machine frame; and
a control apparatus configured to control an operation of the earth working machine, the control apparatus including:
an operating module including a plurality of selectively actuatable operating elements, actuation of the operating elements being operable to change an operating state of the earth working machine;
an at least two-part housing configured to receive the operating module, the housing including a lower shell and an upper shell movable relative to each other between a closed position and an open position, wherein the operating elements of the operating module are accessible in the open position of the housing when the operating module is received in the housing; and
wherein the operating module is separable from the housing and the operating module can be positioned on each of the upper shell and the lower shell in a functionally ready state.

17. The self-propelled earth working machine of claim 16, wherein:
each of the upper shell and the lower shell includes a concave inner side configured to receive the operating module; and
the concave inner sides of the upper shell and the lower shell face each other in the closed position of the housing.

18. The self-propelled earth working machine of claim 16, wherein:
the upper shell and the lower shell are pivotable relative to each other about a pivot axis.

19. The self-propelled earth working machine of claim 16, further comprising:
a carrier component connected to the machine frame; and
wherein the lower shell is configured to be releasably or permanently connected to the carrier component.

20. The self-propelled earth working machine of claim 16, wherein:
at least one of the upper shell or the lower shell includes an opening; and
in an operationally ready state of the earth working machine an electrical connecting line is routed through the opening to the operating module.

21. The self-propelled earth working machine of claim 16, wherein:
at least one of the upper shell or the lower shell includes on an outer side an external electrical connection interface for electrical connection to at least one on-board line of the earth working machine, and the at least one of the upper shell or the lower shell includes a concave inner side including an internal electrical connection interface connected in electrically conductive fashion to the external electrical connection interface, the internal electrical connection interface being configured for electrical connection to the operating module.

22. The self-propelled earth working machine of claim 16, wherein:
each of the upper shell and the lower shell includes a fastening formation; and
the operating module includes a counterpart fastening formation configured such that the counterpart fastening formation can be brought into a releasable form-locking engagement with either of the fastening formations to secure the operating module on each of the upper shell and the lower shell.

23. The self-propelled earth working machine of claim 22, wherein:
each of the upper shell and the lower shell includes a concave inner side including an internal electrical connection interface; and
the fastening formations and the counterpart fastening formation are configured such that when establishing the releasable form-locking engagement between the fastening formation of the upper shell or lower shell and the counterpart fastening formation of the operating module an electrically conductive connection is automatically established between the internal electrical connection interface of the respective shell and a counterpart electrical connection interface of the operating module.

24. The self-propelled earth working machine of claim 16, wherein:
the control apparatus includes a data processing system situated outside of the operating module and supported by the machine frame, the data processing system being connected to the operating module for the transmission of signals.

25. The self-propelled earth working machine of claim 16, wherein:
the operating module includes at least one output apparatus configured to output signals and/or data.

26. The self-propelled earth working machine of claim 16, wherein:
the operating module is a first operating module; and
the self-propelled earth working machine further includes a second operating module, wherein each of the first and second operating modules is configured to be positioned in a functionally ready state in each of the upper shell and the lower shell.

27. The self-propelled earth working machine of claim 16, wherein:
the housing includes a second lower shell and a second upper shell.

28. The self-propelled earth working machine of claim 27, wherein:
the second lower shell and the second upper shell are pivotable relative to each other about a second pivot axis.

29. The self-propelled earth working machine of claim 16, wherein:
the housing is configured in mirror symmetry with respect to a plane of symmetry.

30. The self-propelled earth working machine of claim 16, wherein the earth working machine is a slipform paver.
